(19) United States
(12) Patent Application Publication
(10) Pub. No.: US 2022/0326911 A1
(43) Pub. Date: Oct. 13, 2022

(54) PRODUCT-SUM CALCULATION DEVICE AND PRODUCT-SUM CALCULATION METHOD

(71) Applicant: FUJITSU LIMITED, Kawasaki-shi (JP)

(72) Inventor: Kazuhiro Abe, Funabashi (JP)

(73) Assignee: FUJITSU LIMITED, Kawasaki-shi (JP)

(21) Appl. No.: 17/573,027

(22) Filed: Jan. 11, 2022

(30) Foreign Application Priority Data
Apr. 12, 2021 (JP) 2021-066868

(51) Int. Cl. G06F 7/544; G06F 7/487

(52) U.S. Cl. CPC G06F 7/5443; G06F 7/4876

(57) ABSTRACT

A product-sum calculation device multiplies first and second floating-point numbers and sequentially adds multiplication results. The device adds a first exponent and a second exponent of the respective floating-point numbers for generating a third exponent, multiplies a first mantissa and a second mantissa of the respective floating-point numbers for generating a third mantissa, sets lower n bits of the third exponent to zero and generates a fourth exponent, shifts the third mantissa to the left by the number of bits indicated by the lower n bits and generated a fourth mantissa, generates an error detection code for each 2ⁿ bits of the fourth mantissa, performs digit alignment of the fourth mantissa and a fifth mantissa and outputs an exponent as a new fifth exponent, and adds the fourth mantissa and the fifth mantissa and outputs an addition result as a new fifth mantissa.

### CROSS-REFERENCE TO RELATED APPLICATION

This application is based upon and claims the benefit of priority of the prior Japanese Patent Application No. 2021-66868, filed on Apr. 12, 2021, the entire contents of which are incorporated herein by reference.

### FIELD

The embodiments discussed herein are related to a product-sum calculation device and a product-sum calculation method.

### BACKGROUND

A shift circuit has been known that can shift an arbitrary number of bits by shifting data including a plurality of bytes in byte units, and then, shifting the data in bit units. In this type of shift circuit, in a case where the data includes a parity for each byte, it is not necessary to provide a prediction circuit for the shifted parity by shifting the data in byte units.

Furthermore, a method is known in which an adder that adds floating-point number data performs addition using fixed point number data converted from the floating-point number data and converts an addition result into the floating-point number data.

Japanese Laid-open Patent Publication No. 61-148527, and Japanese Laid-open Patent Publication No. 2016-157299 are disclosed as related art.

### SUMMARY

According to an aspect of the embodiments, a product-sum calculation device that multiplies first floating-point number data and second floating-point number data and sequentially adds multiplication results, the device including: a first adder configured to add a first exponent of the first floating-point number data and a second exponent of the second floating-point number data and generate a third exponent; a multiplier configured to multiply a first mantissa of the first floating-point number data and a second mantissa of the second floating-point number data and generate a third mantissa; a devaluation circuit configured to set lower n bits (n is integer equal to or more than one) of the third exponent to zero and generate a fourth exponent; a first shift circuit configured to shift the third mantissa to the left by the number of bits indicated by a value of the lower n bits of the third exponent and generate a fourth mantissa; an error code generation circuit configured to generate an error detection code for each 2ⁿ bits of the fourth mantissa; a second shift circuit configured to perform digit alignment of the fourth mantissa and a fifth mantissa on the basis of a difference between the fourth exponent and a fifth exponent and output an exponent that corresponds to the digit-aligned mantissa as a new fifth exponent; and a second adder configured to add the fourth mantissa and the fifth mantissa, on which digit alignment is performed, and output an addition result as a new fifth mantissa.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an example of a calculation device according to one embodiment;

FIG. 2 is a block diagram illustrating an example of a calculation device according to another embodiment;

FIG. 3 is an explanatory diagram illustrating an example of a mantissa generated by a left shift circuit in FIG. 1;

FIG. 4 is a block diagram illustrating an example of a digit alignment shift circuit in FIG. 2;

FIG. 5 is a block diagram illustrating an example of a right shift circuit in FIG. 4;

FIG. 6 is a block diagram illustrating an example of another calculation device;

FIG. 7 is an explanatory diagram illustrating an example of a digit alignment shift circuit in FIG. 6;

FIG. 8 is a block diagram illustrating an example of a right shift circuit in FIG. 7;

FIG. 9 is a circuit diagram illustrating an example of a shift circuit 212a in FIG. 8;

FIG. 10 is an explanatory diagram illustrating an example of an operation of the shift circuit 212a in FIG. 8; and

FIG. 11 is a block diagram illustrating an example of a calculation device according to still another embodiment.

### DESCRIPTION OF EMBODIMENTS

In a case where a calculation device such as a floating-point product-sum operator executes processing for sequentially adding multiplication results, an addition by an addition circuit is performed after a digit alignment shift circuit performs digit alignment of a mantissa of the multiplication result and a mantissa of the previous addition result. The number of bit shifts of the mantissa in digit alignment is a value determined according to a difference between an exponent of the multiplication result and an exponent of the previous addition result. Therefore, in the digit alignment shift circuit, a parity generation circuit that generates a parity of the mantissa on which digit alignment has been performed is provided. In a case where the digit alignment shift circuit is included in a loop path for a product-sum calculation, a circuit delay of the digit alignment shift circuit such as the parity generation circuit or the like easily affects an increase in a calculation time of the calculation device.

In one aspect, an object of the embodiment is to reduce a circuit delay of a digit alignment shift circuit in a calculation device that performs a product-sum calculation.

Hereinafter, embodiments are described with reference to the drawings.

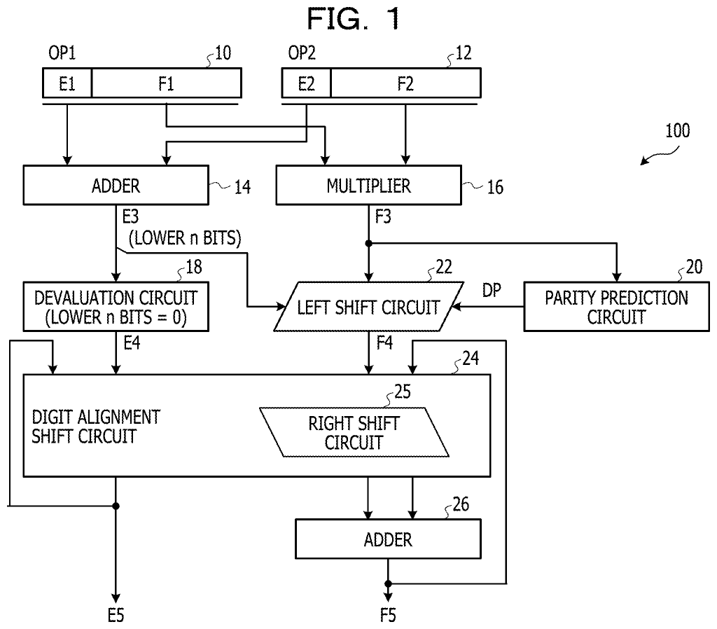

In FIG. 1, an example of a calculation device according to one embodiment is illustrated. A calculation device 100 illustrated in FIG. 1 is, for example, a product-sum operator that performs a product-sum calculation of floating-point number data and is mounted on a processor or the like. The calculation device 100 executes processing for multiplying operands OP1 and OP2 and sequentially adding multiplication results so as to achieve a calculation method.

The calculation device 100 includes registers 10 and 12, an adder 14, a multiplier 16, a devaluation circuit 18, a parity prediction circuit 20, a left shift circuit 22, a digit alignment shift circuit 24, and an adder 26. The adder 14 is an example of a first adder. The left shift circuit 22 is an example of a first shift circuit. The digit alignment shift circuit 24 is an example of a second shift circuit. The adder 26 is an example of a second adder.

The registers 10 and 12 hold operands OP1 and OP2 to be calculated. The operand OP1 includes an exponent E1 and a mantissa FL The operand OP2 includes an exponent E2 and a mantissa F2. Note that parity data may also be added to each of the operands OP1 and OP2 for each predetermined number of bits of the mantissae F1 and F2.

For example, the double precision floating point number format of the Institute of Electrical and Electronics Engineers (IEEE) 754 (floating point number operation standard) is used, the exponents E1 and E2 are 11 bits, the mantissae F1 and F2 are 52 bits, and a sign bit is one bit. In a case where the single precision floating point number format of the IEEE 754 is used, the exponents E1 and E2 are eight bits, the mantissae F1 and F2 are 23 bits, and the sign bit is one bit. Note that, in the following description, it is assumed that positive values be used, and the sign bit is omitted.

The adder 14 adds the exponents E1 and E2 and outputs an addition result as an exponent E1 The multiplier 16 multiplies the mantissae F1 and F2 and outputs a multiplication result as a mantissa F3. Note that the multiplier 16 may also add parity data to the mantissa F3 that is the multiplication result for each predetermined number of bits. Furthermore, the multiplier 16 may also be protected by a residual check method.

The devaluation circuit 18 executes devaluation processing of the exponent E3 by setting lower n bits of the exponent E3 from the adder 14 to zero. Note that it is sufficient that n be an integer equal to or more than one. The number n is determined corresponding to the number of bits 2ⁿ of the mantissa F3 that is used to generate each parity DP by the parity prediction circuit 20. In the following description, it is assumed that n be two.

The parity prediction circuit 20 generates a parity DP for each four bits (2ⁿ bits) for four types of mantissae F4 generated in a case where the mantissa F3 is shifted to the left at all bit values 0 to 3 indicated by the lower two bits of the exponent E3. The parity prediction circuit 20 outputs the generated parity DP to the left shift circuit 22. In the following, each piece of 2ⁿ⁻bit data (mantissa) that is a parity DP generation unit is referred to as a digit. For example, 2ⁿ bits of the data are referred to as a first digit, a second digit, a third digit, . . . , from the lower bit side.

The left shift circuit 22 shifts each bit of the mantissa F3 to the left only by a bit value (any one of zero to three) of lower two bits of the exponent E3. As a result, the mantissa F3 can be increased according to the bit value of the lower two bits of the exponent E3 devaluated by the devaluation circuit 18. In other words, a decrease in the exponent E4 with respect to the exponent E3 can offset as an increase in the mantissa F4 with respect to the mantissa F3, and floating-point number data indicated by the exponent E4 and the mantissa F4 can be the same as floating-point number data indicated by the exponent E3 and the mantissa F3.

Furthermore, the left shift circuit 22 selects a parity DP corresponding to the bit value of the lower two bits of the exponent E3 among the parities DP corresponding to the four types of mantissae F4 generated by the parity prediction circuit 20. Then, the left shift circuit 22 embeds the selected parity DP into the mantissa F4. The parity prediction circuit 20 and a functional unit that selects a correct parity DP from among the parities DP corresponding to the four types of mantissae F4 in the left shift circuit 22 are examples of an error code generation circuit. The parity DP is an example of an error detection code.

The digit alignment shift circuit 24 performs digit alignment of the floating-point number data indicated by the exponent E4 and the mantissa F4 and the floating-point number data indicated by an exponent E5 and a mantissa F5 and outputs the mantissa F4 and the exponent E5, on which digit alignment has been performed. The adder 26 adds the mantissa F4 on which digit alignment has been performed by the digit alignment shift circuit 24 and the mantissa F5 that is a previous addition result and outputs the addition result as a new mantissa F5. For example, the adder 26 includes a parity prediction circuit (not illustrated) that predicts a parity DP corresponding to the new mantissa F5 that is the addition result of the mantissae F4 and F5. Because the parity prediction circuit included in the adder 26 operates in parallel to an addition operation by the adder 26, a delay penalty is small.

For example, the digit alignment shift circuit 24 includes a right shift circuit 25 that shifts a mantissa corresponding to an exponent having a smaller value of the exponents E4 and E5 to the right by an absolute value of a difference between the exponents E4 and E5. The digit alignment shift circuit 24 outputs a larger one of the exponents E4 and E5 as an exponent E5.

In a case where the exponent E4> the exponent E5, the right shift circuit 25 shifts the mantissa F5 to the right by the exponent E4-the exponent E5. In a case where the exponent E4< the exponent E5, the right shift circuit 25 shifts the mantissa F4 to the right by the exponent E5-E4. In a case where the exponent E4 = the exponent E5, the right shift circuit 25 outputs the mantissae F4 and F5 to the adder 26 without performing right-shifting.

Lower two bits of the exponent E4 are zero due to the devaluation by the devaluation circuit 18. Because the exponent E5 is generated on the basis of the exponent E4 of which the lower two bits are set to zero, the lower two bits of the exponent E5 are zero. Therefore, it is possible to constantly set a shift amount by the right shift circuit 25 in four-bit units (2ⁿ units).

For example, in a case where the right shift circuit 25 shifts the mantissa F4, the parity DP generated by the parity prediction circuit 20 can be used as a parity DP for the shifted mantissa. Furthermore, in a case where the right shift circuit 25 shifts the mantissa F5, the parity DP generated by the adder 26 to be described later can be used as the parity DP for the shifted mantissa.

Therefore, a parity prediction circuit that predicts the parity DP corresponding to the mantissa shifted by the right shift circuit 25 can be omitted. In a case where the parity prediction circuit is mounted on the digit alignment shift circuit 24, a parity DP predicted by the parity prediction circuit is supplied to the right shift circuit 25. Therefore, the digit alignment shift circuit that mounts the parity prediction circuit has a longer bit shift time of the right shift circuit 25 than that of the digit alignment shift circuit 24 that does not mount the parity prediction circuit.

In this embodiment, because the digit alignment shift circuit 24 does not need to mount the parity prediction circuit, a circuit delay of the digit alignment shift circuit 24 can be reduced. For example, the bit shift time of the right shift circuit 25 can be shortened. As a result, a digit alignment time of the mantissae F4 and F5 can be shortened, and a time required for a product-sum calculation can be shortened. A calculation time shortening effect increases as the number of times of product-sum calculations increases.

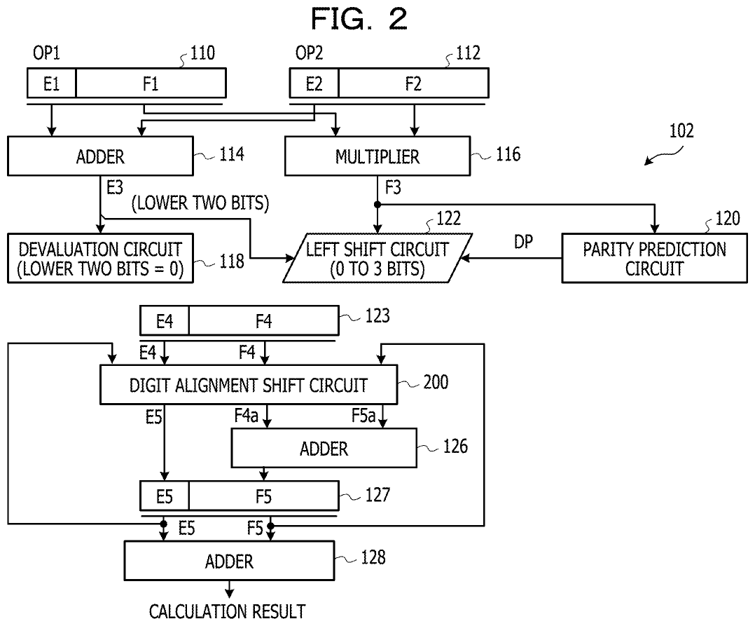

FIG. 2 illustrates an example of a calculation device according to another embodiment. Detailed description of elements similar to those in FIG. 1 will be omitted. A calculation device 102 illustrated in FIG. 2 is a product-sum operator that performs a product-sum calculation of floating-point number data, similarly to the calculation device 100 in FIG. 1. For example, the calculation device 102 achieves a calculation method of a product-sum calculation. In this embodiment, it is assumed that a parity DP be generated for each four bits (2ⁿ bits; n is two) of a mantissa F3.

The calculation device 102 includes registers 110 and 112, an adder 114, a multiplier 116, a devaluation circuit 118, a parity prediction circuit 120, a left shift circuit 122, and an intermediate register 123. Furthermore, the calculation device 102 includes a digit alignment shift circuit 200, an adder 126, a loopback register 127, and a normalized shift circuit 128. The intermediate register 123 and the loopback register 127 are arranged to divide a clock cycle.

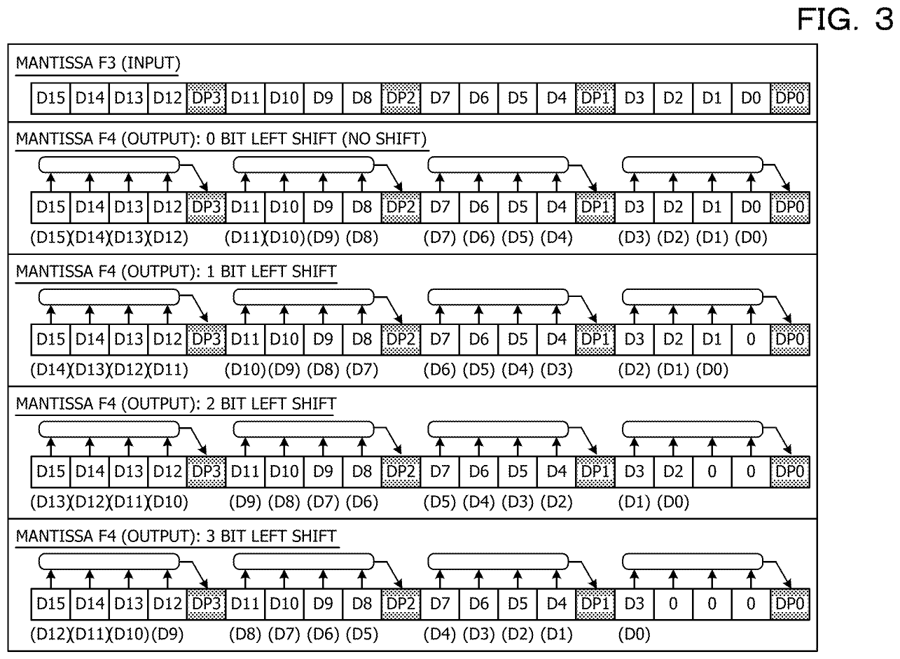

Functions of the registers 110 and 112, the adder 114, and the multiplier 116 are similar to the functions of the registers 10 and 12, the adder 14, and the multiplier 16 in FIG. 1. Functions of the devaluation circuit 118, the parity prediction circuit 120, the left shift circuit 122, and the adder 126 are similar to the functions of the devaluation circuit 18, the parity prediction circuit 20, the left shift circuit 22, and the adder 26 in FIG. 1. For example, the left shift circuit 122 shifts each bit of the mantissa F3 to the left only by a bit value (any one of zero to three) of lower two bits of the exponent E3. An example of the mantissa F4 generated by the left shift circuit 122 is illustrated in FIG. 3.

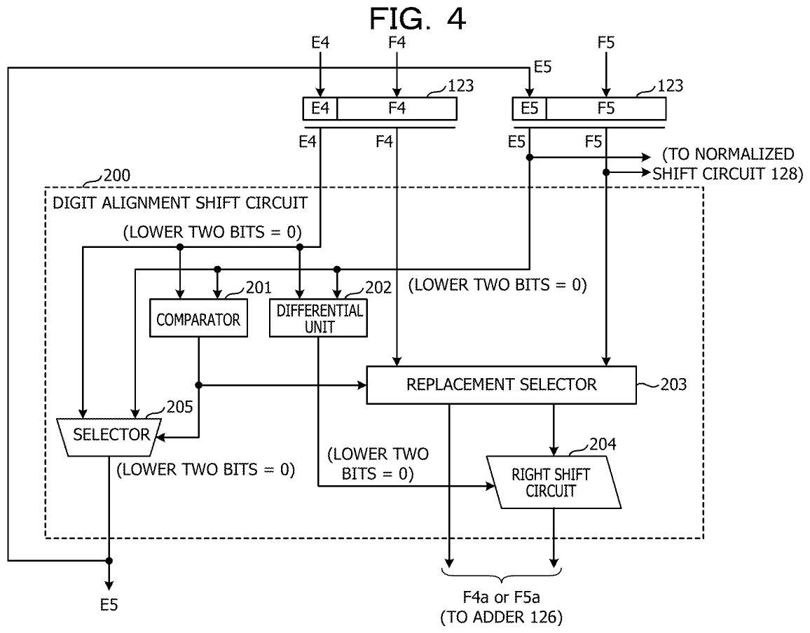

The intermediate register 123 holds an exponent E4 output from the devaluation circuit 118 and a mantissa F4 output from the left shift circuit 122 and outputs the held exponent E4 and mantissa F4 to the digit alignment shift circuit 200. A function of the digit alignment shift circuit 200 is similar to the function of the digit alignment shift circuit 24 in FIG. 1. An example of the digit alignment shift circuit 200 is illustrated in FIG. 4. The loopback register 127 holds the exponent E5 from the digit alignment shift circuit 200 and the mantissa F5 from the adder 126 and outputs the held exponent E5 and mantissa F5 to the digit alignment shift circuit 200 and the normalized shift circuit 128.

The normalized shift circuit 128 executes rounding processing on the mantissa F5 and expresses the mantissa F5 as assuming that there is an implicit one above the most significant bit of the mantissa F5. Furthermore, the normalized shift circuit 128 adjusts the exponent E5 according to the rounding processing. Then, the normalized shift circuit 128 outputs the normalized exponent E5 and mantissa F5 as a calculation result.

In FIG. 3, an example of the mantissa F4 generated by the left shift circuit 122 in FIG. 2 is illustrated. For easy understanding, in FIG. 3, lower 16 bits in the mantissae F3 and F4 are extracted. It is assumed that a parity DP be added to each four bits of the mantissae F3 and F4. In this case, the left shift circuit 122 generates the mantissa F4 by left-bit shifting the mantissa F3 by a number as many as a bit value (any one of zero to three) of lower two bits of the exponent E3. Furthermore, parities DP3 to DP0 corresponding to a bit shift amount are selected from among the parities DP (four DP3, four DP2, four DP1, and four DPO corresponding to four bit shift amounts) predicted by the parity prediction circuit 120.

In a case where the shift amount is zero bit, correspondence between each four bits of the mantissa F4 with the parity DP is the same as the correspondence between each four bits of the mantissa F3 with the parity DP. In a case where the shift amounts are one, two, and three bits, the parity DP corresponding to the mantissa F4 is different from the parity DP corresponding to the mantissa F3. Therefore, the left shift circuit 122 selects the parity DP according to the bit shift amount from among the parities DP predicted by the parity prediction circuit 20.

In a region that indicates the mantissa F4 shifted by three bits from zero bit shift in FIG. 3, a broken line of an oval indicates that parities DP (DP3 to PD0) corresponding to the respective four bits in the mantissa F4 are generated. The parity prediction circuit 120 in FIG. 2 generates prediction values of 16 parities DP corresponding to 16 ovals in FIG. 3. Then, as described above, the left shift circuit 122 selects four parities DP according to the bit shift amount from among the 16 parities DP and includes the selected parities DP in the mantissa F4. Furthermore, inside of parentheses below each data bit indicates a bit position before shifting the corresponding data bit.

FIG. 4 is a block diagram illustrating an example of the digit alignment shift circuit 200 in FIG. 2. The digit alignment shift circuit 200 includes a comparator 201, a differential unit 202, a replacement selector 203, a right shift circuit 204, and a selector 205.

The comparator 201 compares the exponent E4 from the intermediate register 123 and the exponent. E5 from the loopback register 127 and outputs a comparison result to the selector 205 and the replacement selector 203. The differential unit 202 calculates a difference between the exponent E4 from the intermediate register 123 and the exponent E5 from the loopback register 127 as an absolute value and outputs the calculated difference to the right shift circuit 204. Here, because lower bits of both of the exponents E4 and E5 are zero, lower two bits of the difference output by the differential unit 202 are zero.

The replacement selector 203 outputs one of the mantissae F4 and F5 having the smaller one of the exponents E4 and E5 to the right shift circuit 204 on the basis of the comparison result by the comparator 201 and outputs a mantissa having the larger one of the exponents E4 and E5 to the adder 126. Note that, in a case where the exponents E4 and E5 are equal to each other, the replacement selector 203 outputs the mantissae F4 and F5 to the right shift circuit 204 and the adder 126, respectively, without replacing the mantissae F4 and F5.

The right shift circuit 204 shifts the mantissa (F4 or F5) supplied from the replacement selector 203 to the right only by the number of bits indicated by the difference from the differential unit 202 and outputs the right-shifted mantissa to the adder 126. The right shift circuit 204 is an example of a bit shift circuit. Here, because lower two bits of the difference output from the differential unit 202 are zero, a right shift amount is a multiple of four.

Therefore, a parity DP corresponding to the right-shifted mantissa can use a parity DP corresponding to a mantissa before being right-shifted without newly generating the parity DP. As a result, because it is not necessary to provide a parity prediction circuit corresponding to the right shift circuit 204, a shift operation by the right shift circuit 204 can be performed at higher speed than that in a case where the parity prediction circuit is provided.

The selector 205 outputs the larger one of the exponents E4 and E5 as a new exponent E5 on the basis of the comparison result by the comparator 201. Here, because lower bits of the exponents E4 and E5 are zero, lower two bits of the new exponent E5 output by the selector 205 are also zero.

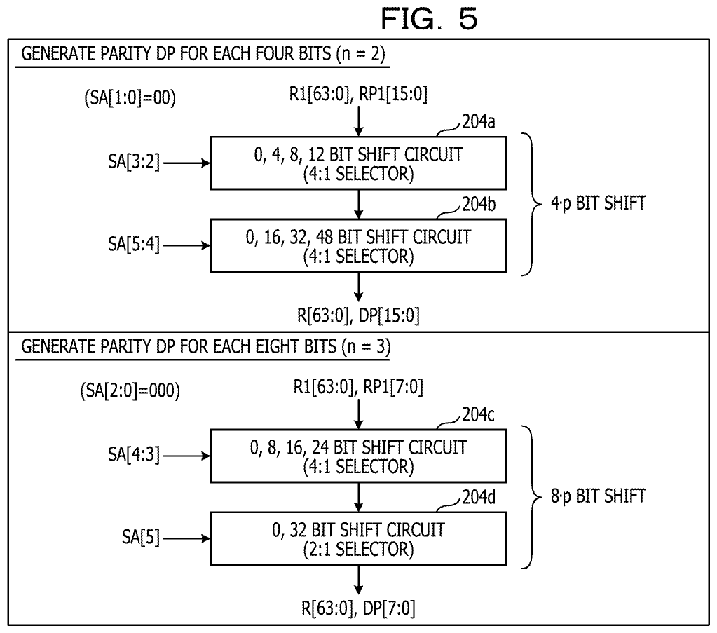

FIG. 5 is a block diagram illustrating an example of the right shift circuit 204 in FIG. 4. In FIG. 5, for example, an example in which a parity DP [15:0] is generated for each four bits of 64-bit data R [63:0] and an example in which a parity DP [7:0] is generated for each eight bits of the 64-bit data R [63:0] are illustrated. The data R corresponds to a mantissa F. A reference numeral SA indicates a shift amount signal indicating a shift amount from zero bit to 63 bits and corresponds to the difference output from the differential unit 202 in FIG. 4.

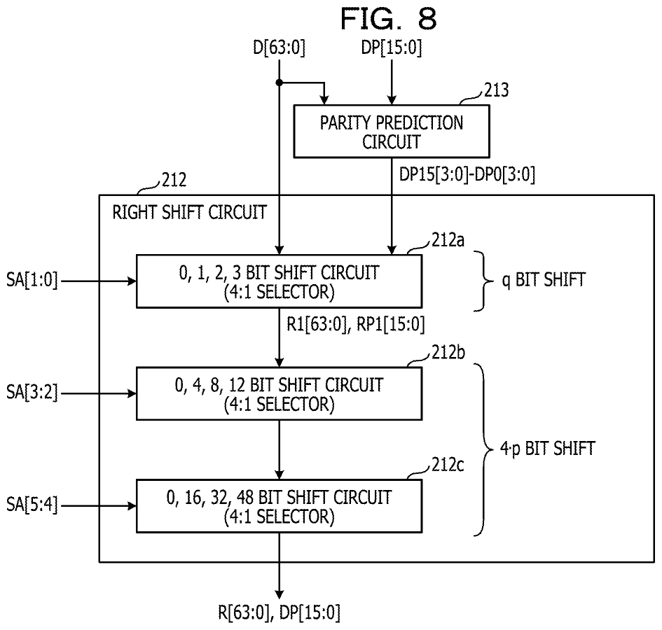

In a case where the parity DP is generated for each four bits (n=2), the left shift circuit 122 in FIG. 2 performs left-shifting by a number same as the bit value of the lower two bits of the exponent E3 in advance. Therefore, a shift amount signal SA [1:0] is constantly 00, and it can be unnecessary to include a shift circuit (shift circuit 212a to be described later illustrated in FIG. 8 or the like) that shifts data R1 [63:0] to the right by zero bit, one bit, two bits, or three bits.

A shift circuit 204a in a first stage receives the mantissa F4 generated by the left shift circuit 122 or the mantissa F5 held by the loopback register 127. Then, the shift circuit 204a uses a 4:1 selector according to a shift amount signal SA [3:2] and shifts the data R1 [63:0] to the right by zero bit, four bits, eight bits, or 12 bits.

A shift circuit 204b at a second stage uses a 4:1 selector according to a shift amount signal SA [5:4] and shifts data output from the shift circuit 204a to the right by zero bit, 16 bits, 32 bits, or 48 bits. As a result, the right shift circuit 204 can shift 4·p (p is integer equal to or more than zero) bits to the right according to a shift amount signal SA [5:0] and generate the data R [63:0] and a parity DP [15:0]. Note that, because a correspondence relationship between the four bits of the data R [63:0] and each parity DP does not change, the parity DP [15:0] is not newly generated and is reused.

In a case where a parity DP is generated for each eight bits (n =3), a left shift circuit corresponding to the left shift circuit 122 in FIG. 2 performs left-shifting in advance by a number as many as the bit value of the lower three bits of the exponent E3. Therefore, the shift amount signal SA [2:0] is constantly 000. A shift circuit 204c at a first stage uses a 4:1 selector according to a shift amount signal SA [4:3] and shifts the data R1 [63:0] and a parity RP1 [7:0] to the right by zero bit, eight bits, 16 bits, or 24 bits.

A shift circuit 204d at a second stage uses a 2:1 selector according to a shift amount signal SA [5] and shifts data output from the shift circuit 204c to the right by zero bit or 32 bits. As a result, the right shift circuit 204 can shift 8·p (p is integer equal to or more than zero) bits to the right according to a shift amount signal SA [5:0] and generate the data R [63:0] and the parity DP [7:0]. Note that, because a correspondence relationship between the eight bits of the data R [63:0] and each parity DP does not change, the parity DP [7:0] is not newly generated and is reused.

As illustrated in FIG. 5, for example, the right shift circuit 204 that generates the parity DP for each four bits in the digit alignment shift circuit 200 can include the two-stage shift circuits 204a and 204b. Similarly, the right shift circuit 204 that generates the parity DP for each eight bits in the digit alignment shift circuit 200 can include the two-stage shift circuits 204c and 204d. Because the right shift circuit 204 can omit a shift circuit corresponding to the shift amount signal SA [2:0], it is possible to achieve acceleration for one stage of the shift circuit.

As described above, in the present embodiment, as in the embodiment described above, it is possible to make the parity prediction circuit be unnecessary to be mounted on the digit alignment shift circuit 200. Therefore, a circuit delay of the digit alignment shift circuit 200 can be reduced. Moreover, in the present embodiment, in the right shift circuit 204, it can be unnecessary to provide the shift circuit that shifts the data R1 [63:0] to the right by zero bit, one bit, two bits, or three bits. Therefore, a time required for a shift operation by the right shift circuit 204 can be shortened for one stage of the shift circuit, and the circuit delay of the digit alignment shift circuit 200 can be further reduced.

As a result, it is possible to perform a floating-point product-sum calculation by the calculation device 102 at high speed, and it is possible to enhance a performance of the calculation device 102. For example, a clock frequency of the calculation device 102 can be increased by reducing a delay time of a critical path from the intermediate register 123 to the loopback register 127.

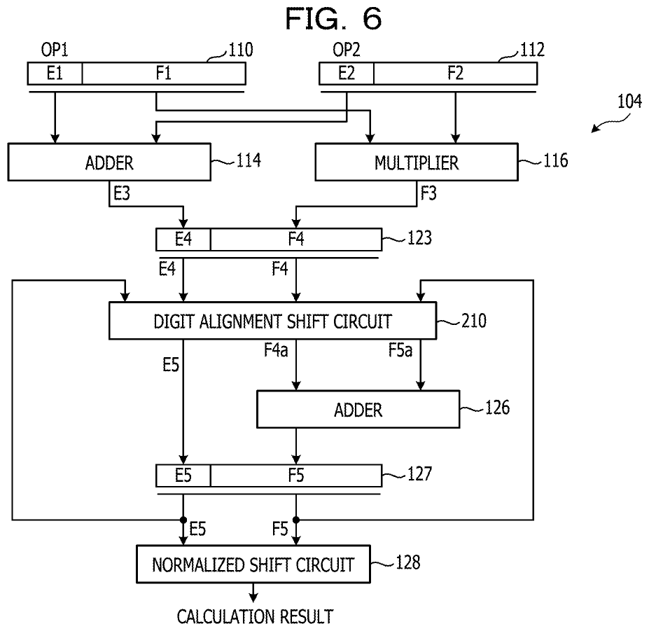

FIG. 6 is a block diagram illustrating an example of another calculation device. Elements similar to those in FIG. 2 are denoted by the same reference numerals, and detailed description is omitted. A calculation device 104 illustrated in FIG. 6 does not include the devaluation circuit 118, the parity prediction circuit 120, and the left shift circuit 122 in FIG. 2. Therefore, the exponent E3 output from the adder 114 and the mantissa F3 output from the multiplier 116 are held by the intermediate register 123 as the exponent E4 and the mantissa F4. Furthermore, the calculation device 104 includes a digit alignment shift circuit 210 instead of the digit alignment shift circuit 200 in FIG. 2. Other components of the calculation device 104 are similar to the components of the calculation device 102 in FIG. 2.

The exponent E4 stored in the intermediate register 123 is an addition result of the exponents E1 and E2 by the adder 114, and lower two bits of the exponent E4 are any one of zero to three. Similarly, the exponent E5 stored in the loopback register 127 is a result of digit alignment in one-bit units, and lower two bits of the exponent E5 are any one of zero to three.

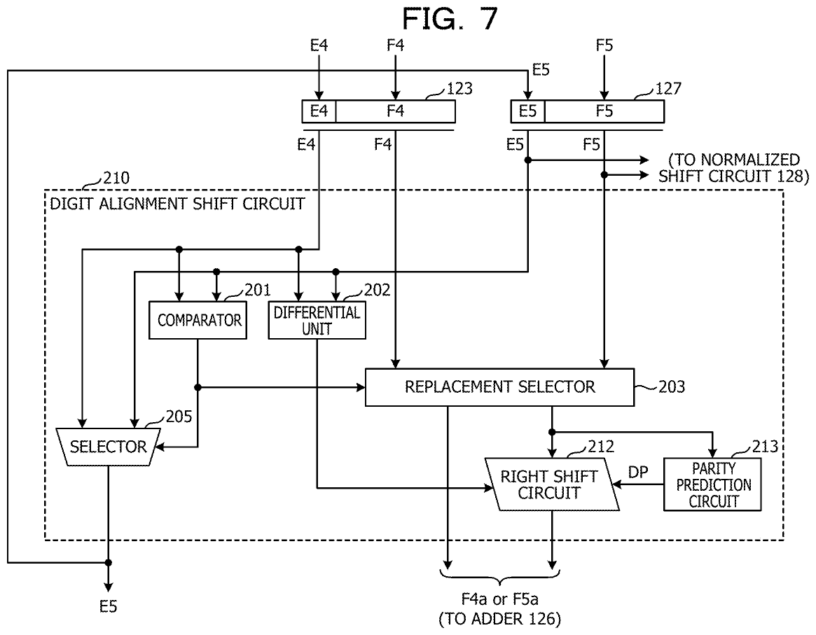

FIG. 7 is a block diagram illustrating an example of the digit alignment shift circuit 210 in FIG. 6. Elements similar to those in FIG. 4 are denoted by the same reference numerals, and detailed description is omitted. The digit alignment shift circuit 210 includes a right shift circuit 212 and a parity prediction circuit 213 instead of the right shift circuit 204 of the digit alignment shift circuit 200 in FIG. 4. Furthermore, lower two bits of the exponents E4 and E5 supplied to the digit alignment shift circuit 210, lower two bits of a difference output from the differential unit 202, and lower two bits of the exponent E5 output from the selector 205 are any one of zero to three.

Therefore, the right shift circuit 212 performs right-bit-shifting in one bit units, for example, from zero bit to 63 bits according to the difference output from the differential unit 202. Because right-bit-shifting is not performed in four bit units, the digit alignment shift circuit 210 predicts a parity DP with respect to a mantissa on which right-bit-shifting has been performed by the parity prediction circuit 213.

FIG. 8 is a block diagram illustrating an example of the right shift circuit 212 in FIG. 7. Detailed description of elements similar to those in FIG. 5 will be omitted. In FIG. 8, for example, an example is illustrated in which a parity DP [15:0] is generated for each four bit of 64-bit data R [63:0]. The right shift circuit 212 includes shift circuits 212a, 212b, and 212c having a three-stage configuration. Functions of the shift circuits 212b and 212c are respectively the same as the functions of the shift circuits 204a and 204b in FIG. 5.

The shift circuit 212a uses the 4:1 selector according to a shift amount signal SA [1:0] and shifts the data D [63:0] to the right by zero bit, one bit, two bits, or three bits. For example, the shift circuit 212a shifts the data D [63:0] to the right by q (q is any one of zero to three) bits according to the shift amount signal SA [1:0] and outputs the data as the data R1 [63:0].

Furthermore, the shift circuit 212a selects the parity DP [15:0] corresponding to each four bits of the data R1 [63:0] according to a shift amount from among the parities DP output from the parity prediction circuit 213. Then, the shift circuit 212a outputs the data R1 [63:0] and the parity RP1 [15:0] to the shift circuit 212b.

In this way, in a case where the right shift amount by the shift circuit 212a is not in four bits units, the parity prediction circuit 213 is provided that predicts the parity DP added to the data R1 [63:0] shifted by the shift circuit 212a. This causes a delay penalty used for parity generation. Furthermore, the right shift circuit 212 mounts shift circuits 212a, 212b, and 212c that include one more stage than that in FIG. 5. Therefore, a time required for a right shift operation according to the shift amount signal SA [5:0] is longer than the right shift circuit 204 in FIG. 5.

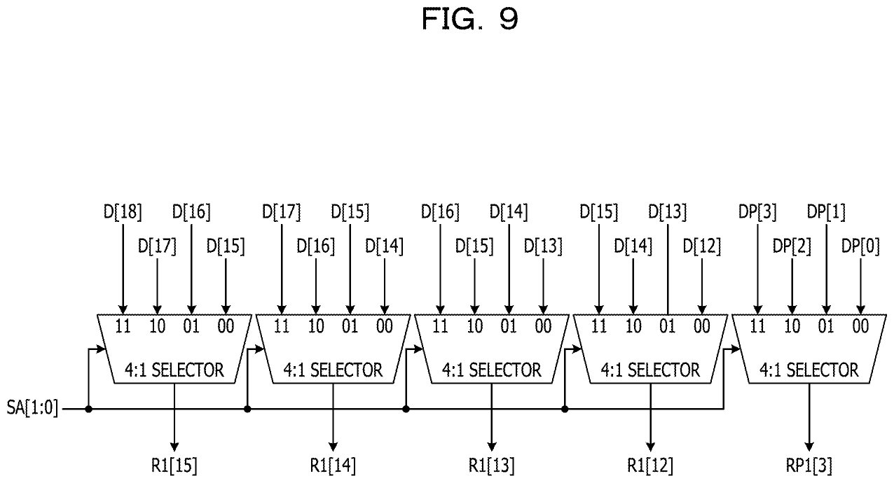

FIG. 9 is a circuit diagram illustrating an example of the shift circuit 212a in FIG. 8. In FIG. 9, an example of a 4:1 selector corresponding to a third digit (R1 [15:12], RP1 [3]) in the shift circuit 212a is illustrated. Each 4:1 selector selects an input corresponding to a bit value of the shift amount signal SA [1:0] and outputs the selected input as data R1 [15:12] and the parity RP1 [³] . For example, in a case where the bit value of the shift amount signal SA [1:0] is 01, five 4:1 selectors output data D [16:13] and the parity DP [1] respectively as the data R1 [15:12] and the parity RP1 [3].

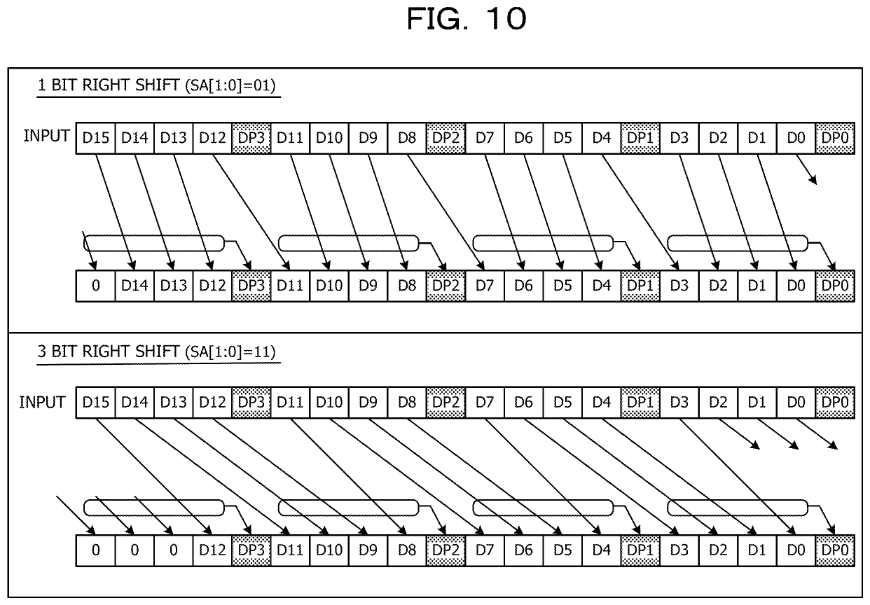

FIG. 10 illustrates an example of an operation of the shift circuit 212a in FIG. 8. Detailed description of the operations similar to those in FIG. 3 will be omitted. In FIG. 10, a one-bit right-shift example and a three-bit right-shift example are illustrated.

In a case where the shift amount signal SA [1:0] =01, the shift circuit 212a shifts each bit to the right by one bit, inserts zero to the most significant bit, and gets the least significant bit out. Furthermore, the shift circuit 212a selects a corresponding parity DP from among the parities DP predicted by the parity prediction circuit 213 in correspondence with each shifted digit (four bits).

In a case where the shift amount signal SA [1:0]=11, the shift circuit 212a shifts each bit to the right by three bits, inserts zero into the most significant three bits, and gets the least significant three bits out. Furthermore, the shift circuit 212a selects a corresponding parity DP from among the parities DP predicted by the parity prediction circuit 213 in correspondence with each shifted digit (four bits).

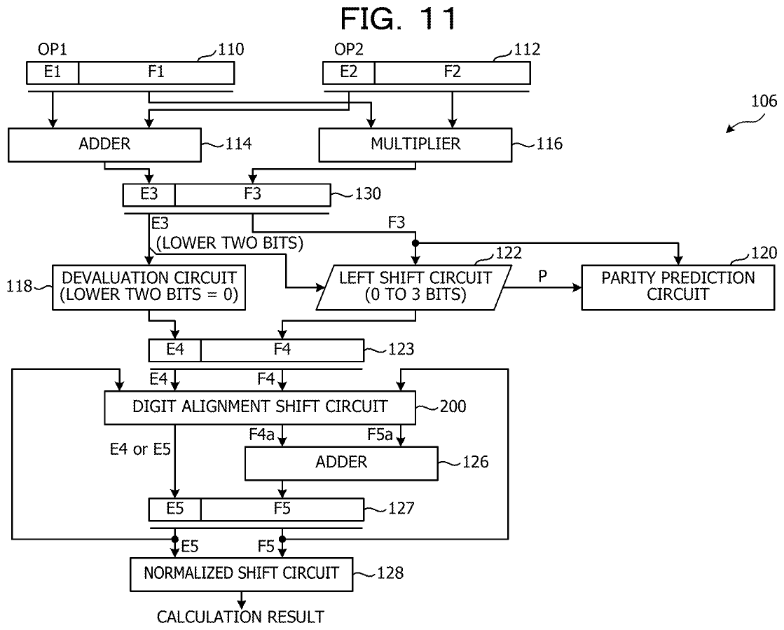

FIG. 11 illustrates an example of a calculation device according to another embodiment. Elements similar to those in FIG. 4 are denoted by the same reference numerals, and detailed description is omitted. A calculation device 106 illustrated in FIG. 11 includes an intermediate register 130 that holds the exponent E3 output from the adder 114 and the mantissa F3 output from the multiplier 116. Then, the calculation device 106 achieves a calculation method of a product-sum calculation.

The devaluation circuit 118 executes devaluation processing of the exponent E3 by setting lower two bits of the exponent E3 held by the intermediate register 130 to zero. The left shift circuit 122 shifts each bit of the mantissa F3 held by the intermediate register 130 to the left by a bit value of the two lower bits of the exponent E3 held by the intermediate register 130 (any one of zero to three).

Note that the lower two bits correspond to n of the number of bits 4 (=2ⁿ) of the mantissa F3 used to generate each parity DP by the parity prediction circuit 120. Therefore, the number of lower bits of the exponent E3 set to zero by the devaluation circuit 118 is not limited to two bits, and may also be determined as n in correspondence with the number of bits 2ⁿ of the mantissa F3 used to generate each parity DP by the parity prediction circuit 120.

For example, the intermediate register 130 is arranged in a case where a sum of a multiplication time by the multiplier 116 and operation times by the parity prediction circuit 120 and the left shift circuit 122 exceeds a clock cycle time required for the multiplication of the mantissae F1 and F2 by the multiplier 116. As a result, the parity prediction circuit 120 and the left shift circuit 122 can be arranged between the multiplier 116 and the intermediate register 123 without decreasing a clock frequency.

On the other hand, in a case where the intermediate register 130 is not arranged, the sum of the multiplication time by the multiplier 116 and a circuit delay time by the parity prediction circuit 120 and the left shift circuit 122 is included in the clock cycle time required for the multiplication of the mantissae F1 and F2 by the multiplier 116. Therefore, in a case where the sum of the multiplication time by the multiplier 116 and the operation times by the parity prediction circuit 120 and the left shift circuit 122 is set to be within the clock cycle time required for the multiplication of the mantissae F1 and F2 by the multiplier 116, it is necessary to decrease the clock frequency. In this case, there is a possibility that an effect of reducing the circuit delay of the digit alignment shift circuit 200 included in the loop path is canceled by the decrease in the clock frequency, and there is a possibility that a performance of the calculation device 106 is deteriorated.

As described above, in this embodiment, effects similar to those of the above-described embodiment can be obtained. Moreover, in the present embodiment, by arranging the intermediate register 130 according to the circuit delay time of the parity prediction circuit 120 and the left shift circuit 122, it is possible to achieve the functions of the digit alignment shift circuit 200 described above without decreasing the clock frequency. As a result, it is possible to perform a floating-point product-sum calculation by the calculation device 106 at high speed, and it is possible to enhance a performance of the calculation device 106.

From the detailed description above, characteristics and advantages of the embodiments will become apparent. This intends that claims cover the characteristics and advantages of the embodiment described above without departing from the spirit and the scope of the claims. Furthermore, one of ordinary knowledge in the technical field may easily achieve various improvements and modifications. Therefore, there is no intention to limit the scope of the inventive embodiments to those described above, and the scope of the inventive embodiment may rely on appropriate improvements and equivalents included in the scope disclosed in the embodiment.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be under stood that the various changes, substitutions, and alterations could be made hereto without departing from the spirit and scope of the invention.

What is claimed is:

1. A product-sum calculation device that multiplies first floating-point number data and second floating-point number data and sequentially adds multiplication results, the device comprising:
a first adder configured to add a first exponent of the first floating-point number data and a second exponent of the second floating-point number data and generate a third exponent;
a multiplier configured to multiply a first mantissa of the first floating-point number data and a second mantissa of the second floating-point number data and generate a third mantissa;
a devaluation circuit configured to set lower n bits (n is integer equal to or more than one) of the third exponent to zero and generate a fourth exponent;
a first shift circuit configured to shift the third mantissa to the left by the number of bits indicated by a value of the lower n bits of the third exponent and generate a fourth mantissa;
an error code generation circuit configured to generate an error detection code for each 2ⁿ bits of the fourth mantissa;
a second shift circuit configured to perform digit alignment of the fourth mantissa and a fifth mantissa on the basis of a difference between the fourth exponent and a fifth exponent and output an exponent that corresponds to the digit-aligned mantissa as a new fifth exponent; and
a second adder configured to add the fourth mantissa and the fifth mantissa, on which digit alignment is performed, and output an addition result as a new fifth mantissa.

2. The product-sum calculation device according to claim 1, wherein
the second shift circuit includes a bit shift circuit that performs bit-shift on either the fourth mantissa or the fifth mantissa generated by the first shift circuit in units of the 2ⁿ bits.

3. The product-sum calculation device according to claim 1, further comprising:
a register configured to hold the third exponent output from the first adder and the third mantissa output from the multiplier, output the held third exponent to the devaluation circuit, and output the held third mantissa to the first shift circuit.

4. A product-sum calculation method for multiplying first floating-point number data and second floating-point number data and sequentially adding multiplication results, the method comprising:
generating a third exponent by adding a first exponent of the first floating-point number data and a second exponent of the second floating-point number data;
generating a third mantissa by multiplying a first mantissa of the first floating-point number data and a second mantissa of the second floating-point number data;
generating a fourth exponent by setting lower n bits (n is integer equal to or more than one) of the third exponent to zero;
generating a fourth mantissa by shifting the third mantissa to the left by the number of bits indicated by a value of the lower n bits of the third exponent;
generating an error detection code for each 2ⁿ bits of the fourth mantissa;
performing digit alignment of the fourth mantissa and a fifth mantissa on the basis of a difference between the fourth exponent and a fifth exponent and outputting an exponent that corresponds to the digit-aligned mantissa as a new fifth exponent; and
adding the fourth mantissa and the fifth mantissa, on which the digit alignment is performed, and outputting an addition result as a new fifth mantissa.
